(19) United States
(12) Patent Application Publication
(10) Pub. No.: US 2017/0230180 A1
(43) Pub. Date: Aug. 10, 2017

(54) INCLUDING NODE AND PROCESS IDENTIFIERS IN A TRANSACTION

(71) Applicant: HEWLETT PACKARD ENTERPRISE DEVELOPMENT LP, Houston, TX (US)

(72) Inventors: Melvin K. Benedict, Houston, TX (US); Michael R. Krause, Palo Alto, CA (US); Mitchel E. Wright, Houston, TX (US)

(21) Appl. No.: 15/515,258

(22) PCT Filed: Oct. 29, 2014
(86) PCT No.: PCT/US2014/062848

§ 371 Date: Mar. 29, 2017

(51) Int. Cl. H04L 9/32; H04L 29/06; H04L 29/12; G06F 21/62; G06F 13/40; H04L 12/64; G06F 12/10

(52) U.S. Cl. CPC H04L 9/32; H04L 12/6418; H04L 63/04; H04L 63/08; H04L 63/10; G06F 12/10; G06F 21/62; G06F 13/4022; H04L 29/1283; H04L 61/6018; H04Q 2213/13339

(57) ABSTRACT

A receiver node receives, over a communication fabric, a transaction packet that includes an identifier of a sender node and an identifier of a process at the sender node, the transaction packet sent by the process for a transaction. The receiver node performs authentication for the transaction based on the identifier of the process and the identifier of the sender node.

### BACKGROUND

Devices can be connected to a communication fabric to allow the devices to communicate with each other. The communication fabric can include communication nodes (e.g. switches or routers) for forwarding or relaying messages and traffic between the devices.

### BRIEF DESCRIPTION OF THE DRAWINGS

Some implementations are described with respect to the following figures.

FIG. 1 is a flow diagram of an example protection process performed by a receiver node, in accordance with some implementations.

FIGS. 2 and 3 are schematic diagrams of example network arrangements according to various implementations.

FIG. 4 is a flow diagram of another example protection process, according to alternative implementations.

FIG. 5 is a block diagram of an example receiver node according to some implementations.

FIG. 6 is a block diagram of an example sender node according to some implementations.

### DETAILED DESCRIPTION

A communication fabric provided for an enterprise (e.g. business concern, educational organization, government agency, etc.) can be coupled to a relatively large number of endpoint devices. Examples of endpoint devices include computers (e.g. desktop computers, notebook computers, tablet computers, server computers, etc.), handheld devices (e.g. smartphones, personal digital assistants, etc.), storage systems (e.g. memory devices or modules, persistent storage devices or arrays, etc.), processors, graphics controllers, network interface controllers, and/or other types of electronic devices or electronic components. More generally, an endpoint device can refer to an entire machine that has multiple electronic components, or alternatively, an endpoint device can refer to an electronic component within a machine

The communication fabric can be coupled to endpoint devices at a single geographic location, or alternatively, can be coupled to endpoint devices at various different geographic locations, which can be spread out across a state or province, across a country, or across the world.

Security can be a challenge in a communication fabric. In some examples, endpoint devices on a communication fabric may not be authorized devices; in other words, these endpoint devices should not have been allowed to communicate over the communication fabric (such endpoint devices can be referred to as “rogue” devices). In other examples, endpoint devices that are authorized can be exposed to malware or other types of unauthorized programs (e.g. software, firmware, or more generally, machine-readable instructions) that may execute on the endpoint devices.

Various resources are accessible over a communication fabric. Examples of resources include memory regions of one or multiple memory devices, persistent storage regions of one or multiple persistent storage devices, processing resources (resources of one or multiple processors), communication resources (resources that are used to perform communications), graphics resources (resources used for graphics processing, such as image or video processing), and/or other types of resources. Privileges may be defined for endpoint devices—these privileges can define rights of corresponding endpoint devices to access certain resources but not other resources. Enforcing such privileges can be a challenge in a large communication fabric that is coupled to a wide variety of endpoint devices.

In accordance with some implementations, fabric-wide protection techniques or mechanisms are provided to protect a communication fabric from unauthorized access of resources or unauthorized communications over a communication fabric. The protection techniques or mechanisms can employ process identifiers (IDs) and node IDs included in transaction packets. A transaction packet can carry various information that relate to a transaction. A transaction can refer to any interaction or session between two or more than two nodes. For example, a transaction can refer to a memory read operation that is initiated by a memory read request, a memory write operation that is initiated by a memory write request, a operation that invokes a functionality of a graphics controller, a network interface controller, another input/output (I/O) controller, an accelerator, and so forth.

In some examples, a transaction packet can carry a request sent from one node to another node to perform a requested operation in a respective transaction. In other examples, a transaction packet can carry traffic data related to the transaction from one node to another node. A transaction packet can refer to any data unit that is used to carry information over a communication fabric for a respective transaction.

In this disclosure, a “node” can refer to any electronic device (e.g. an endpoint device or any other type of device, such as a router, a switch, etc., or a component within a machine) that is able to communicate over a communication fabric.

A process ID can refer to an identifier of a process that executes in a node. A process can refer to an instance of a program or an instance of a portion of a program that is executed. A process can also refer to a thread that is started for the program or portion of the program—note that multiple threads can be started for the program (portion). In examples where a process is a thread, then a process ID can also be considered a thread ID. More generally, a process can refer to any instance of machine-readable instructions that execute on a node to perform specified task(s).

A node ID refers to an identifier of a node. Each node is assigned a unique node ID that distinguishes that node from another node. The combination of a node ID and a process ID provides a unique fabric-wide identifier for an entity that is involved in a transaction.

The process ID and node ID included in a transaction packet can be used by a node to perform authentication for a transaction. Performing authentication for a transaction can include one or any combination of the following: (1) determining whether a sender of the transaction is authorized to perform the transaction, or (2) determining whether the sender has a privilege to access a requested resource as part of performing the transaction.

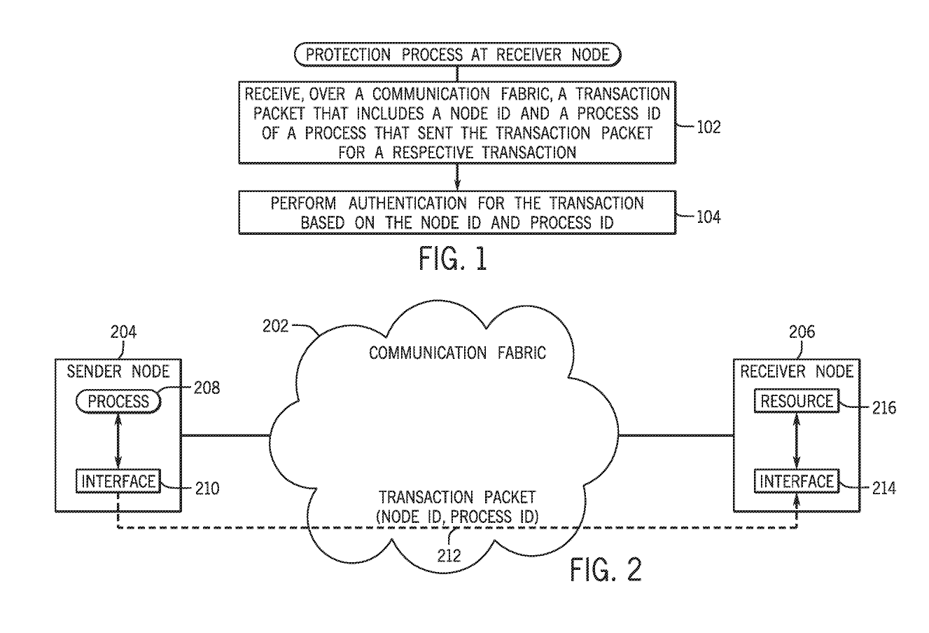

FIG. 1 is a flow diagram of a protection process according to some implementations. The protection process can be performed by a receiver node in response to a communication from a sender node. A “receiver node” can refer to a node that receives a communication from a node that sends the communication (a “sender node”). Note that each node can act as a receiver node in some instances, and as a sender node in other instances.

The receiver node receives (at 102), over a communication fabric, a transaction packet that includes a node ID of the sender node and a process ID of the process at the sender node, where the transaction packet is sent by the process for a respective transaction. The receiver node performs (at 104) authentication for the transaction based on the process ID and the node ID of the sender node.

FIG. 2 is a block diagram of an example arrangement that includes a communication fabric 202, and a sender node 204 and a receiver node 206 that are capable of communicating over the communication fabric 202. The communication fabric 202 includes various communication links (e.g. electrical links, optical links, wireless links, etc.) over which nodes coupled to the communication fabric 202 are able to communicate. In addition, the communication fabric 202 can include communication nodes that are able to forward or relay data over the communication fabric 202. Such communication nodes can include switches, routers, or any other communication node that is able to forward or relay traffic from one endpoint device to another endpoint device (e.g. from the sender node 204 to the receiver node 206). In addition, the communication fabric 202 can include management nodes for performing various management tasks with respect to the communication fabric 202.

Although just one sender node 204 and one receiver node 206 are shown as coupled to the communication fabric 202, it is noted that in other examples, additional endpoint nodes can be coupled to the communication fabric 202.

The sender node 204 includes a process 208 that executes in the sender node 204. The process can be an instance of a program (or an instance of a portion of a program) that has been loaded for execution in the sender node 204. The program can include a software application, an operating system module, firmware, a virtualization layer for performing virtualization in the sender node 204, or any other type of machine-readable instructions. Note that in some cases, the process 208 can be a thread (of multiple threads) that can be invoked for a given program.

The sender node 204 also includes an interface 210 that includes logic and circuitry to allow the sender node 204 to communicate over the communication fabric 202. The interface 210 can include a physical layer that transmits and receives signals over links of the communication fabric 202. Note that the interface 210 can also include upper layers above the physical layer. These upper layers can include a protocol layer that operates according to a protocol used for communications over the communication fabric 202. This protocol can be referred to as an “interconnect protocol,” which is discussed further below.

In addition, the interface 210 can also include logic to perform various tasks, including address translation and protection-related tasks. Address translation can refer to translating an address for a transaction between a first address space and a second address space. As examples, address translations can include an address translation from a first physical address space to a second physical address space, an address translation from a virtual address space to a physical address space, an address translation from a physical address space to a virtual address space, and an address translation between a first virtual address space and a second virtual address space.

Protection-related tasks can include the adding of the node ID and the process ID in one or multiple fields of a transaction packet, where the node ID and process ID can be used for performing authentication according to some implementations, as discussed above.

In FIG. 2, in response to a request of the process 208, the interface 210 sends a transaction packet 212 through the communication fabric 202 to the receiver node 206. The transaction packet 212 includes a node ID (that identifies the sender node 204), a process ID (that identifies the process 208), and other information. For example, if the transaction packet 212 includes a request (e.g. a request to read data or a request to write data), then the other information included in the transaction packet 212 can specify the address to be read or written, or can include a data to be written. In other examples, the transaction packet 212 can carry data that is to be communicated from the sender node 204 to the receiver node 206.

The receiver node 206 includes an interface 214 that allows the receiver node 206 to communicate over the communication fabric 202. Similar to the interface 210 in the sender node 204, the interface 214 in the receiver node can include a physical layer, a protocol layer, and logic to perform address translation and protection-related tasks. The protection-related tasks performed by the interface 214 in the receiver node 206 can include using the process ID and node ID in the transaction packet 212 to perform authentication for the transaction related to the transaction packet 212.

The authentication performed by the interface 214 can include one or any combination of the following: (1) determining whether a sender of the transaction packet 212 is authorized to perform the transaction, or (2) determining whether the sender has a privilege to access a requested resource (e.g. resource 216 associated with the receiver node 206). Note that “sender” can refer to the combination of the sender node 204 and the process 208 in the sender node 204 that issued the transaction 212.

Although the resource 216 is shown as being included in the receiver node 206, it is noted that in other examples, the resource 216 can be external of the receiver node 206, but is accessible by the receiver node 206. More generally, the resource 216 can be considered to be associated with the receiver node 206, where the resource 216 can be included in the receiver node 206 or is external but accessible by the receiver node 206.

As noted above, the interface 210 or 214 can include a protocol layer that is able to communicate over the communication fabric 202 using an interconnect protocol. In some implementations, the interconnect protocol can support or employ memory semantic operations over the communication fabric 202. A “memory semantic operation” can refer to an operation that employs memory requests to communicate between a sender node and a receiver node. For example, the sender node can be a processor, while the receiver node can be a memory. The memory requests can include a read request, a write request, an atomic operation request, and so forth, which can be issued by the sender node to access data in the receiver node. In some implementations, the interconnect protocol can support memory semantic operations as well as other types of operations between a sender node and a receiver node.

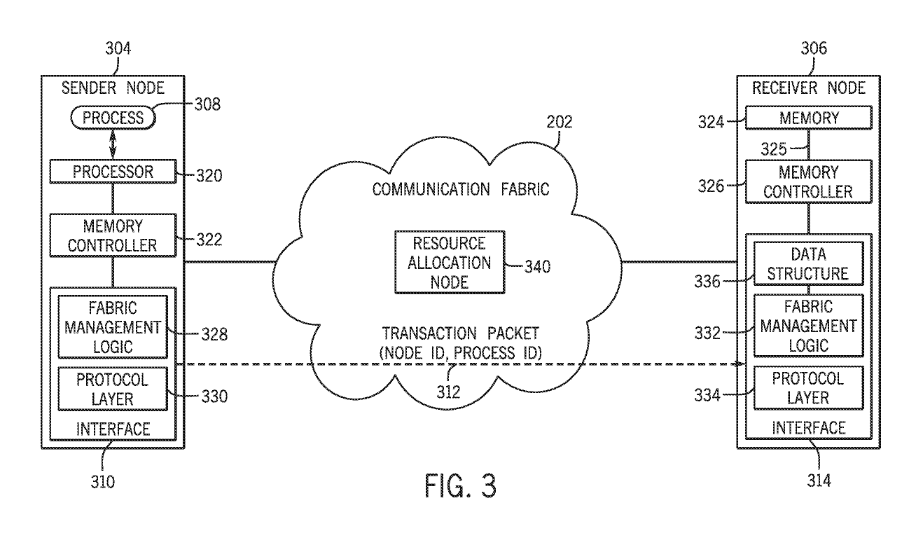

FIG. 3 is a schematic diagram of another example arrangement according to alternative implementations. FIG. 3 shows a sender node 304 and a receiver node 306 coupled to the communication fabric 202. Similar to the example shown in FIG. 2, the sender node 304 is able to send a transaction packet 312 over the communication fabric 202 to the receiver node 306, where the transaction packet 312 includes a node ID of the sender node 304 and a process ID of a process 308 executing in the sender node 304 that issued a request that resulted in the sending of the transaction packet 312.

The sender node 304 includes one or multiple processors 320, which can be coupled to a memory controller 322. The process 308 executing on the processor(s) 320 is able to issue a request to access a memory 324 associated with the receiver node 306, where the memory 324 can be included in the receiver node 306 or is external to the receiver node 306 but accessible by the receiver node 306.

The request triggered by the process 308 is sent by the processor(s) 320 to the memory controller 322. The memory controller 322 then issues a memory request in response to the request from the processor 320, where the memory request is to be communicated in a transaction packet 312 to the receiver node 306. A memory request can be a memory read request, a memory write request, a memory request that performs an atomic operation, and so forth.

The memory request from the memory controller 320 can pass to an interface 310 of the sender node 304, which sends the transaction packet 312 (carrying the memory request) over the communication fabric 202. The transaction packet is received by an interface 314 in the receiver node 306. The interface 314 extracts the memory request from the transaction packet 312, and passes the memory request in the transaction packet 312 to a media controller 326 in the receiver node 306. The media controller 326 performs an access of the memory 324 in response to the received memory request. For example, the media controller 326 issues a memory command (or multiple memory commands) over a memory bus 325 between the media controller 326 and the memory 324, where the memory command(s) is (are) responsive to the memory request carried in the transaction packet 312.

As shown in FIG. 3, a split memory control architecture is employed, where the split memory control architecture includes the memory controller 322 (located in the sender node 304) and the media controller 326 (located in the receiver node 306).

By using the split memory control architecture, the memory controller 322 in the sender node 304 does not have to be concerned with issuing commands that are according to specifications of the memory 324. Note that the sender node 304 can access different receiver nodes that include different types of memories, each having respective different specifications. As examples, the different types of memories can include dynamic random access memories (DRAMs), static random access memories (SRAMs), flash memories, or other types of memories.

The memory 324 can be associated with a specification that governs characteristics of the commands used to control the memory. The characteristics of the commands can include timings of signals on the memory bus 325, specific signals used, types of low-level commands, and so forth. The signals and the low-level commands are those signals and commands that are provided to the memory to affect an operation of the memory. The memory controller 322 can issue a transaction-level request that is independent of the specification governing access of a specific memory. A transaction-level request is a request to read data, write data, or perform other memory operation, at the level of a transaction. The transaction-level request does not include low-level commands that are according to the specification of a memory that is to be accessed.

A transaction-level request from the memory controller 322 is received by a respective media controller (e.g. 326), which is able to respond to the transaction-level request by producing low-level command(s) that is (are) according to the specification governing access of the target memory 324. For example, the low-level command can be a read command, a write command, or another type of command, which has a format and a timing that is according to the specification. In addition to producing low-level command(s) responsive to a transaction-level request from the memory controller 322, the media controller 326 is also able to perform other tasks with respect to the memory 324. For example, if the memory 324 is a DRAM, then the media controller 326 is able to perform refresh operations with respect to the DRAM. A storage cell in a DRAM gradually loses its charge over time. To address this gradual loss of charge in a storage cell, a DRAM can be periodically refreshed, to restore the charge of storage cells to their respective levels.

In other examples, if the memory 324 is implemented with a flash memory, then the media controller 326 can include wear-leveling logic to even out the wear among the storage cells of the memory 324. In addition, the media controller 326 can perform other media-specific operations with respect to the memory 324, such as a data integrity operation (e.g. error detection and correction), a data availability operation (e.g. failover in case of memory error), and so forth. The media controller 326 can also perform power management (e.g. reduce power setting of the memory 324 when not in use), statistics gathering (to gather performance statistics of the memory 324 during operation), and so forth.

By separating the memory control architecture into two parts, greater flexibility can be achieved in a system. The memory controller 322 does not have to be concerned with the specific types of memories used, since transaction-level requests issued by the memory controller 322 would be the same regardless of the type of memory being targeted. By splitting the memory controller 322 from media controllers, development of the memory controller 322 can be simplified.

The interface 310 of the sender node 304 includes a fabric management logic 328 and a protocol layer 330. Similarly, the interface 314 of the receiver node 306 includes a fabric management logic 332 and a protocol layer 334. The protocol layers 330 and 334 allow for communication according to the interconnect protocol over the communication fabric 202.

The fabric management logic 328 or 332 can perform various tasks, including address translation (to translate an address of a transaction packet between a first address space and a second address space) and protection-related tasks as noted above. In the sender node 304, the fabric management logic 328 can add a node ID of the sender node 304 and a process ID of the process 308 to the transaction packet 312 that is sent over the communication fabric 202.

In the receiver node 306, the fabric management logic 332 is able to perform authentication based on the node ID and the process ID included in the transaction packet 312. In some examples, the fabric management logic 332 is able to compare the node ID and the process ID (in the transaction packet 312) to the content of a data structure 336 (accessible by the fabric management logic 332) that stores information specifying resources that are accessible to respective senders, where each sender is represented by a corresponding unique combination of a node ID and process ID. In the example of FIG. 3, the resource includes a memory region in the memory 324. As an example, the data structure 336 can include multiple entries, where each entry maps a specific memory region of the memory 324 to respective combinations of the node ID and process ID that identify senders that are permitted to access the memory region. For example, a first entry of the data structure 336 can specify that a sender associated with a first combination of a process ID and a node ID can access a first memory region, a second entry of the data structure 336 can specify that a sender associated with a second combination of a process ID and a node ID can access a second memory region, and so forth. Note that an entry can identify multiple senders that are permitted to access a given memory region.

In some examples, the data structure 336 can include a page table having entries that determine which senders are permitted to access respective pages (examples of memory regions) of the memory 324. In other examples, the data structure 336 can include a local descriptor table (which includes memory segment descriptors of segments of the memory 324), or other types of data structures.

In other examples, the receiver node 306 can include a different type of resource (different from the memory 324). In such other examples, the media controller 326 can be omitted from the receiver node 306, with the media controller 326 replaced with a different resource controller for managing access of the different resource. This different resource controller receives a corresponding request from the memory controller 322 (in a transaction packet sent over the communication fabric 202) and can perform access of the resource in response to such a request from the memory controller 322.

As further shown in FIG. 3, the communication fabric 202 can include a resource allocation node 340, which is able to allocate a resource (or segment of the resource) to a specific sender. For example, the resource allocation node 340 can allocate a memory region of the memory 324 to a specific process executing in a specific sender node. The resource allocation node 340 can provide the node ID and the process ID of this sender to the receiver node associated with the resource (segment), such that the receiver node can store the information pertaining to the resource (segment) along with the node ID and process ID of the authorized sender in a data structure (e.g. 336).

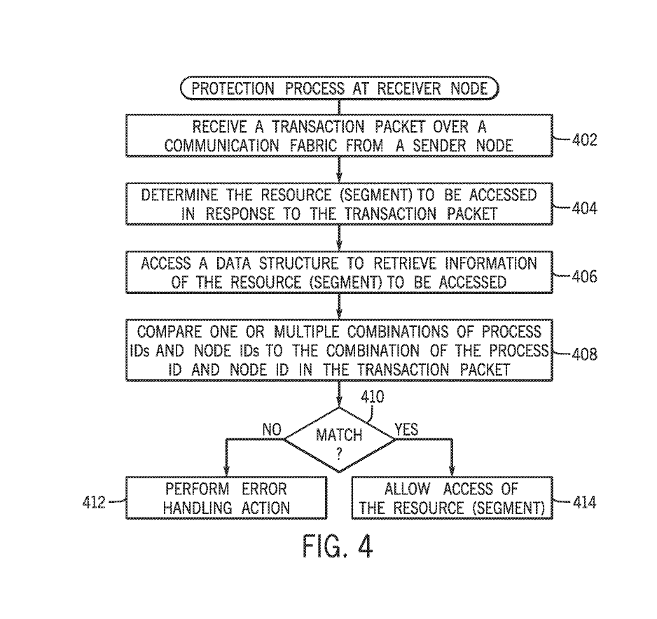

FIG. 4 is a flow diagram of a protection process performed by a receiver node (e.g. 206 in FIG. 2 or 306 in FIG. 3) according to alternative implementations. The receiver node receives (at 402) a transaction packet over the communication fabric 202 from a sender node (e.g. 204 in FIG. 2 or 304 in FIG. 3). The receiver node determines (at 404) the resource (or segment of the resource) to be accessed in response to the transaction packet. The receiver node then accesses (at 406) a data structure (e.g. 336 in FIG. 3) to retrieve information pertaining to the resource (segment) that is being accessed in response to the transaction packet. The receiver node compares (at 408) one or multiple combinations of process IDs and node IDs retrieved from the data structure 336 for the requested resource (segment) to the combination of the node ID and process ID included in the received transaction packet.

The receiver node determines (at 410) whether there is a match indicated by the comparing. If not, an error handling action is performed (at 412). However, if the comparing results in a match, then the receiver node allows (at 414) access of the resource (segment).

The error handling action can include any or some combination of the following. The receiver node can send an indication of the error to the sender node, to allow the sender node (and more specifically, a program at the sender node) to handle the error. Alternatively, the error handling action can include logging the information pertaining to the transaction along with the process ID and the node ID to allow for identification of the sender (the combination of the sender node and the process executing in the sender node that issued the transaction). In some cases the error handling action can include denying access to the requested resource (segment), or alternatively, access to the resource (segment) can be granted subject to notification of an entity (e.g. an administrator or a management node in the communication fabric 202) regarding the authentication error.

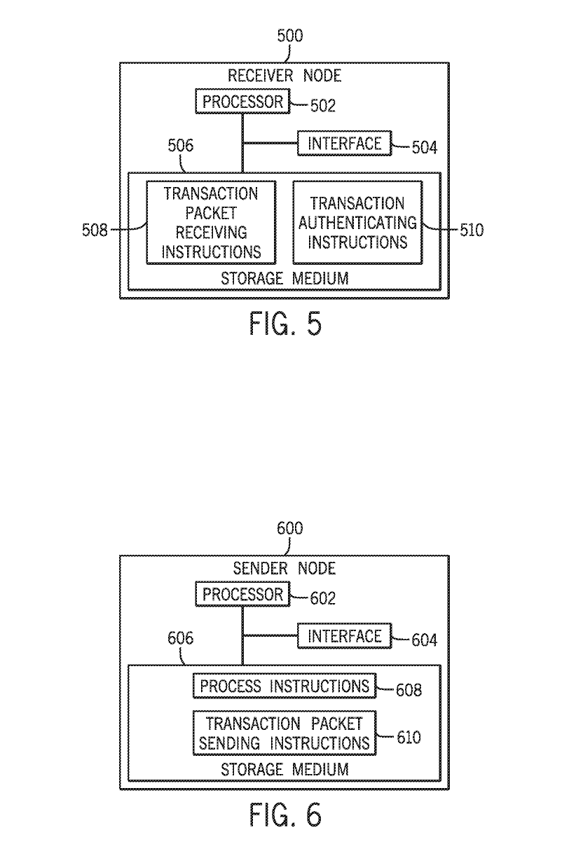

FIG. 5 is a block diagram of an example receiver node 500 according to some implementations, such as the receiver node 206 or 306. Note that the receiver node 104 can represent an entire machine or component within a machine (or within an arrangement of machines). The receiver node 500 includes a processor (or multiple processors) 502. A processor can include a microprocessor, microcontroller, physical processor module or subsystem, programmable integrated circuit, programmable gate array, or another physical control or computing device.

The processor(s) 502 can be coupled to an interface 504 (e.g. 310 in FIG. 3) to allow for communication over the communication fabric 202. In addition, the processor(s) 502 can be coupled to a non-transitory computer-readable or machine-readable storage medium (or storage media) 506.

The storage medium (or storage media) 506 can store machine-readable instructions, such as transaction packet receiving instructions 508 to receive a transaction packet sent by a sender node over the communication fabric, and transaction authenticating instructions 510 to authenticate the transaction based on a node ID and a process ID. More generally, the machine-readable instructions of the receiver node 500 can perform any of the tasks discussed above, such as those shown in FIG. 1 or 4, or tasks of the fabric management logic 332 and/or protocol layer 334 of FIG. 3. The machine-readable instructions are executable on the one or multiple processors 502.

FIG. 6 is a block diagram of an example sender node 600 according to some implementations, such as the sender node 204 or 304. The sender node 600 includes a processor (or multiple processors) 602. Note that the sender node 600 can represent an entire machine or component within a machine (or within an arrangement of machines).

The processor(s) 602 can be coupled to an interface 604 (e.g. 314 in FIG. 3) to allow for communication over the communication fabric 202. In addition, the processor(s) 602 can be coupled to a non-transitory computer-readable or machine-readable storage medium (or storage media) 606.

The storage medium (or storage media) 606 can store machine-readable instructions, such as process instructions 608 (which can be are part of the process 208 or 308, for example), and transaction packet sending instructions 610 to send a transaction packet responsive to a request through an interface of the sender node and over a communication fabric to a receiver node. More generally, the machine-readable instructions of the sender node 600 can perform any other tasks, such as tasks of the fabric management logic 328 and/or protocol layer 330 of FIG. 3. The machine-readable instructions are executable on the one or multiple processors 602.

The storage medium (or storage media) 506 or 606 can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or any other types of volatile or non-volatile storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by a receiver node over a communication fabric, a transaction packet that includes an identifier of a sender node and an identifier of a process at the sender node, the transaction packet sent by the process for a transaction; and
performing, by the receiver node, authentication for the transaction based on the identifier of the process and the identifier of the sender node.

2. The method of claim 1, wherein performing the authentication comprises determining a privilege for the transaction based on the identifier of the process and the identifier of the sender node, the privilege specifying a right to access a resource in response to the transaction packet.

3. The method of claim 2, wherein the resource includes at least one selected from among a memory region, a storage region, a processing resource, a communication resource, and a graphics resource.

4. The method of claim 1, wherein performing the authentication comprises determining whether the process is authorized to perform the transaction.

5. The method of claim 1, wherein receiving the transaction packet comprises receiving the transaction packet from the sender node that includes a memory controller that issued a transaction-level request.

6. The method of claim 5, wherein the receiver node includes a resource controller, the method further comprising:
in response to authenticating the transaction, producing, by the controller based on the transaction-level request, at least one command according to a specification of a resource in the receiver node.

7. The method of claim 6, wherein the resource controller is a media controller, and the resource is a memory, and wherein producing the at least one command based on the transaction-level request is according to a specification of the memory, the specification including a timing of signals.

8. The method of claim 1, further comprising:
receiving, by the receiver node, the process identifier and the node identifier from a node that allocated a resource to the process at the sender node.

9. The method of claim 1, further comprising:
in response to failure of the authentication, accessing, by the receiver node, policy information to determine an action to take.

10. The method of claim 9, further comprising:
performing, by the receiver node, the action, wherein the action includes identifying the process and the sender node based on the process identifier and the sender identifier, and sending error information relating to the failure of the authentication to the sender node for handling the failure at the sender node.

11. The method of claim 9, further comprising:
logging, by the receiver node, information relating to the transaction and identifying the process and the sender node, the logged information used for tracing a source of the transaction that failed the authentication.

12. A receiver node comprising:
an interface to a communication fabric; and
at least one processor to:
receive a transaction packet sent by a sender node over the communication fabric, the transaction packet being part of a transaction and according to a protocol that supports memory semantic operations between nodes on the communication fabric, and wherein the transaction packet includes a node identifier to identify the sender node, and a process identifier to identify a process executing in the sender node; and
authenticate the transaction based on the node identifier and the process identifier.

13. The receiver node of claim 12, further comprising fabric management instructions executable on the at least one processor to:
perform the authenticating of the transaction; and
perform address translation of an address in the translation packet between a first address space and a second address space.

14. The receiver node of claim 12, wherein the transaction packet carries a memory request issued by a memory controller in the sender node, and wherein the receiver node includes a resource controller to issue at least one command to access the resource in response to the memory request, wherein the at least one command conforms to a specification of the resource, and the memory request does not conform to the specification of the resource.

15. An article comprising at least one non-transitory machine-readable storage medium storing instructions that upon execution by a processor of a sender node cause the sender node to:
execute a process on at least one processor of the sender node to issue a request; and
send a transaction packet responsive to the request through an interface of the sender node and over a communication fabric to a receiver node, the transaction packet including a process identifier to identify the process, and a node identifier to identify the sender node, the process identifier and the node identifier included in the transaction packet for use by the receiver node in performing authentication for a transaction associated with the transaction packet.
